(19) United States
(12) Patent Application Publication
(10) Pub. No.: US 2009/0278682 A1
(43) Pub. Date: Nov. 12, 2009

(54) MOBILE DEVICE WITH LOCATING FUNCTION

(75) Inventor: Young-Way Liu, Tucheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/147,371

(22) Filed: Jun. 26, 2008

(30) Foreign Application Priority Data
May 12, 2008 (CN) 200810301543.1

(51) Int. Cl. G08B 21/00; H04Q 7/20

(52) U.S. Cl. 340/540; 455/556.1

(57) ABSTRACT

A mobile device with locating function includes a microphone, an amplifier circuit, an A/D converter, an MPU, and a beacon circuit. The microphone allows sound activation of the locating function of the mobile device. The amplifier circuit is connected to the microphone, and capable of amplifying signals output from the microphone. The A/D converter is connected to the amplifier circuit, and capable of converting the amplified signals to a digital signal. The MPU stores a reference signal therein, and is capable of comparing the digital signal to the reference signal, when the digital signal matches the reference signal, the MPU outputs a control signal. The beacon circuit is connected to the MPU, and is capable of activating an audio and/or visual beacon.

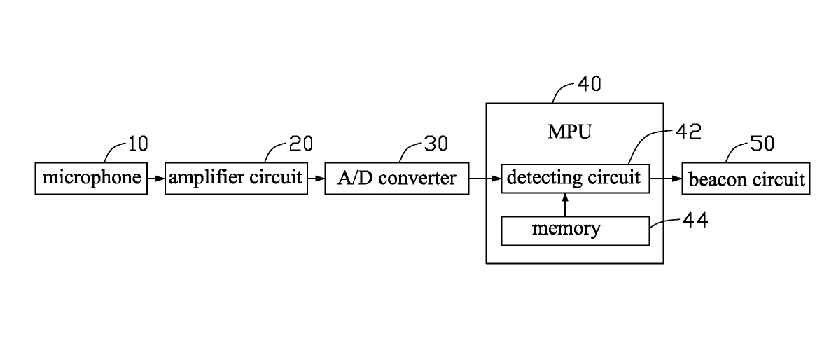

### BACKGROUND

1. Field of the Invention

The present invention relates to mobile devices, and particularly to a mobile device with locating function.

2. Description of Related Art

With the development of mobile technology, mobile devices, such as mobile phones and personal digital assistants (PDAs) are smaller and lighter weight then their predicesors so as to enhance their portability. Such improvements in portability, however, have lead to the mobile devices being easily misplaced or lost, and when this happens, because of their diminutive size, they are difficult to locate.

What is needed, therefore, is to provide a mobile device with locating function to alert a user to the location of the mobile device.

### BRIEF DESCRIPTION OF THE DRAWING

The drawing is a block diagram of a mobile device with locating function in accordance with an embodiment of the present invention.

### DETAILED DESCRIPTION

Referring to the drawing, a mobile device, which may be a mobile phone, in accordance with an embodiment of the present invention includes a microphone 10, an amplifier circuit 20, an A/D converter 30, a micro processing unit (MPU) 40, and a beacon circuit 50. The microphone 10 is configured for picking up sounds in the vicinity of the mobile device and converting the sounds to an analog signal. The amplifier circuit 20 is connected to the microphone 10 and configured for amplifying the analog signal from the microphone 10. The A/D converter 30 is connected to the amplifier circuit 20 and configured for converting the amplified analog signal to a digital signal. The MPU 40 includes a detecting circuit 42 and a memory 44, the detecting circuit 42 is connected to the A/D converter 30 and the memory 44, and the memory 44 stores a reference signal therein. The reference signal can be pre-set by the manufacturer or set by the user. A distinctive sound is chosen then stored in digital format in the memory 44. The reference signal is used to determine if a sound picked up by the microphone 10 is a user signal to activate a locating function of the phone. For example the sound of a hand-clap can be set as the reference signal. The beacon circuit 50 is connected to the detecting circuit 42.

In use, the microphone 10 can be set to be continuously on and is sensitive to sounds around the mobile device. When the microphone 10 picks up a sound around the mobile device, converts the sound to an analog signal and transmits the analog signal to the A/D converter 20. The A/D converter 20 converts the analog signal to a digital signal, and transmits the digital signal to the detecting circuit 42 of the MPU 40. The detecting circuit 42 compares the digital signal to the reference signal stored in the memory 44. If the digital signal matches the reference signal, the detecting circuit 42 sends a signal to the beacon circuit 50. The beacon circuit then causes a beacon to emit locating signals of some kind. For example, a piezo-electric device installed in the device may be controlled to buzz, beep, or chirp at a pre-determined rate for a pre-determined time, or possibly just respond once to each hand-clap. Thus a user can search an area where they misplaced the mobile device and listen for the beacon to respond each time they clap their hands for instance. Specific characteristics of the beacon circuit 50 can be selected and programmed as desired by a manufacturer and are not limited to the examples given in the embodiment. For example, it may be desirable to have a beacon that is both audible and visible, such as a buzzer and flashing diode combination.

In accordance with the invention, the mobile device is designed to notify the user of the position of the mobile device, when the mobile device is lost or misplaced.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A mobile device with locating function, comprising:
a microphone capable of picking up sounds around the mobile device and converting the sounds to an electric signal;
a micro processing unit (MPU) having a reference signal stored therein, and capable of comparing the electric signal to the reference signal; and
a beacon circuit connected to the MPU;
wherein the MPU is capable of outputting a control signal upon a condition that the electric signal matches the reference signal, and the capable of activating a beacon when the beacon circuit receives the control signal.

2. The mobile device as claimed in claim 1 further comprising:
an amplifier circuit connected to the microphone, and capable of amplifying the electric signal.

3. The mobile device as claimed in claim 2 further comprising:
an A/D converter connected to the amplifier circuit, and capable of converting the amplified electric signal from analog format to digital format.

4. The mobile device as claimed in claim 3, wherein the MPU comprises:
a memory, and
a detecting circuit capable of comparing the digital signal with the reference signal.

5. The mobile device as claimed in claim 4, wherein the reference signal is pre-set and stored in digital format in the memory.

6. The mobile device as claimed in claim 1, wherein the mobile device is a mobile phone.

7. The mobile device as claimed in claim 1, wherein the beacon is an audible, visual or an audio and visual signal.

8. The mobile device as claimed in claim 1, wherein the beacon circuit is capable of activating a cell phone speaker.

9. The mobile device as claimed in claim 1, wherein the beacon is a cell phone speaker.

10. The mobile device as claimed in claim 1, wherein the beacon circuit is capable of activating a cell phone ringer even if the cell phone is set to a non-ringing notification mode.

11. The mobile device as claimed in claim 1, wherein the reference signal is related to a clapping sound.

12. A locating method of a mobile device, the method comprising:
receiving sounds around the mobile device;
converting the sounds to signals;
comparing the signals to a preset signal;
upon a condition that the signals matches the reference signal, outputing an audio, a visual or an audio and visual beacon.

13. The locating method as claimed in claim 12 further comprising clapping.

14. A cellular device, comprising:
a microphone;
a micro processing unit (MPU) having a reference signal stored therein:
a beacon circuit;
wherein the MPU is capable of comparing an external sound to the reference signal, upon a condition that the external sound matches the reference signal, the beacon is capable of activating a beacon.
